(19) United States
(12) Patent Application Publication
(10) Pub. No.: US 2017/0072992 A1
(43) Pub. Date: Mar. 16, 2017

(54) STEERING SHAFT FOR A MOTOR VEHICLE STEERING SYSTEM

(71) Applicants: ThyssenKrupp Presta AG, Eschen (LI); ThyssenKrupp AG, Essen (DE)

(72) Inventors: Ulrich Schlegel, Fläsch (CH); Patrick Renggli, Zürich (CH)

(73) Assignees: ThyssenKrupp Presta AG, Eschen (LI); ThyssenKrupp AG, Essen (DE)

(21) Appl. No.: 15/308,403

(22) PCT Filed: Apr. 16, 2015
(86) PCT No.: PCT/EP2015/058236

§ 371 Date: Nov. 2, 2016

(30) Foreign Application Priority Data
May 6, 2014 (DE) 10 2014 106 259.0

(51) Int. Cl. B62D 5/04; F16H 55/06; B29D 15/00; F16H 55/22

(52) U.S. Cl. CPC B62D 5/0409; F16H 55/22; F16H 55/06; B29D 15/00; F16H 2055/065; B29K 2101/00

(57) ABSTRACT

A steering shaft for a motor vehicle steering system may be used with a steering assistance means. The steering shaft may include an output shaft and a carrier that is connected rotationally conjointly to the output shaft. A worm gear toothing may be disposed on the radially outer region of the carrier. The worm gear toothing may comprise plastic and may form a worm gear for connection to the steering assistance means. Further, the carrier may be formed in one piece with the output shaft.

### TECHNICAL FIELD

The present invention relates to a steering shaft for a motor vehicle steering system for use with a steering assistance means, in particular for use with an electric or electromechanical steering assistance means.

### PRIOR ART

Steering shafts for motor vehicle steering systems for use with electric or electromechanical steering assistance means are basically known. The steering shafts have an input shaft which is connected to the steering wheel by way of which the driver of the motor vehicle introduces a steering torque as a steering command into the motor vehicle steering system. An output shaft which is connected to the input shaft is provided, via which output shaft the steering torque is transmitted via track rods to the respective wheels to be steered. To be able to determine the assistance force respectively required of an electric or electrochemical steering assistance means connected to the output shaft, the input shaft and the output shaft are normally connected elastically to one another via a torsion bar, and the torque introduced into the input shaft by the driver can be determined through the determination of a relative twist between the input shaft and the output shaft.

The torque thus determined can constitute the basis for the determination of an assistance torque to be introduced into the steering system or of an assistance force of a steering assistance means for the purposes of steering assistance for the driver.

Steering assistance means, for example electric steering assistance means or electromechanical steering assistance means, are, in order to introduce the corresponding assistance torques, mounted normally on the output shaft, on the steering pinion or on the toothed rack. The respective steering assistance means is in this case actuated by way of the torque introduced into the input shaft by the driver via the steering wheel relative to the output shaft.

Here, it is known for the input shaft and the output shaft of a steering shaft to be connected by way of a torsion bar, and for the input torque to be determined, by way of a torque sensor, from the relative angle of twist between the input shaft and the output shaft. In the case of a hydraulic servo steering system, this may be realized for example by way of a rotary slide valve, and in the case of an electromechanical servo steering system, this may be realized for example by way of corresponding magnetic sensors.

To prevent overloading of the torsion bar, the input shaft and the output shaft may be connected or coupled to one another by way of a loose form fit such that direct form-fitting engagement of the input shaft with the output shaft occurs in the event of a maximum value for the elastic twist of the torsion bar being overshot.

The assistance force is then introduced into the output shaft for example by way of a worm gear which is connected rotationally conjointly to the output shaft and which is acted on by a worm-type drive-output shaft of an electric motor for the introduction of the respective steering assistance torque.

To permit low-friction operation of the drive worm on the worm gear, the worm gear toothing of the worm gear is preferably produced from a plastics material. In this way, noise emissions of the steering assistance means can be reduced.

DE 10 2012 101 383 A1 has disclosed a output shaft with a worm gear, wherein a steel inner sleeve is mounted onto the output shaft and the worm gear toothing is injection-molded onto said steel inner sleeve. The construction is cumbersome owing to the multi-component type of construction.

DE 10 2008 043 214 A1 has disclosed a worm gear which is injection-molded directly onto the output shaft. Since plastic is however generally of a lower strength than steel, said worm gear is of relatively broad construction in an axial direction.

### PRESENTATION OF THE INVENTION

Proceeding from the known prior art, it is correspondingly an object of the present invention to provide a steering shaft for a motor vehicle for use with a steering assistance means, which steering shaft permits a reduced structural space and a simpler construction.

Said object is achieved by way of a steering shaft having the features of claim 1. Advantageous refinements will emerge from the subclaims.

Correspondingly, a steering shaft for a motor vehicle steering system for use with a steering assistance means, comprising an output shaft and comprising a carrier which is connected rotationally conjointly to the output shaft, is proposed, on the radially outer region of which carrier there is provided a worm gear toothing composed of plastic for forming a worm gear for connection to the steering assistance means. According to the invention, the carrier is formed in one piece with the output shaft. In the context of the invention, a steering assistance means is to be understood to mean both to a device which simply introduces an additional assistance force or an additional assistance torque into the steering system in order to reduce the force introduced by hand or the torque introduced by hand into the steering system by the driver, and a device which introduces an additional steer angle into the steering system in addition to the steer angle introduced by the driver, or else a combination of both.

By virtue of the fact that the carrier is formed in one piece with the output shaft, it is possible to dispense with a multi-component design of the output shaft. The carrier and the output shaft may rather be produced jointly in a single step, for example by deformation, preferably by cold extrusion. The strength of the carrier with the output shaft is correspondingly particularly high, and it is possible to dispense with the use of further components for forming the carrier and/or for forming the worm gear.

As a result of the worm gear toothing composed of plastic being applied directly to the radially outer region of the carrier, it is furthermore possible for the structural space to be reduced, because, at least in that region of the output shaft which is close to the axis, the carrier is not provided with a plastics encapsulation. The carrier is formed from the same material as the output shaft itself, that is to say for example from steel. Correspondingly, in the region close to the axis, it is possible, owing to the fact that the carrier is formed in one piece with the output shaft, for the carrier to be formed with a width in an axial direction considerably smaller than would be possible if said carrier were formed using a plastic. This is owing to the higher strength of steel in relation to plastic.

The carrier is preferably of disk-shaped form and comprises, in particular, a ratio of height h1 of the carrier over the output shaft to the width of said carrier of ≧1. The ratio of the height h1 of the carrier over the output shaft to the width b of said carrier is particularly preferably greater than or equal to 2, wherein it is particularly preferable for the ratio to be less than or equal to 4. In other words, the carrier comprises a radial extent or a height over the outer surface of the output shaft as far as the maximum radius of said carrier, which radial extent or height is considerably greater than the width of said carrier. The carrier is correspondingly of substantially disk-shaped form, and is of correspondingly narrow construction.

The worm gear toothing is preferably applied in the radially outer region of the carrier, in such a way that the worm gear toothing surrounds the carrier only to the extent necessary for realizing the strength. Correspondingly, a region of the carrier arranged between output shaft and worm gear toothing can be left free in order reduce the overall structural space and reduce the space taken up as a result of the mounting of the worm gear toothing.

In the outer region of the carrier, in which the worm gear toothing is applied, the carrier preferably comprises a toothing, a knurling, bores or apertures parallel to the shaft axis, or other form-fitting structures which permit a form-fitting connection of the worm gear toothing to the carrier in a direction of rotation. It can correspondingly be ensured that the worm gear toothing does not slip or is not rotated relative to the carrier when an assistance force or an assistance torque is introduced, such that a precise introduction of the assistance force or of the assistance torque into the steering assembly is made possible.

The worm gear toothing is preferably produced from a single plastic, such that, in this case, too, it is possible to dispense with multi-component structures, in order that the steering shaft can be produced inexpensively.

The worm gear toothing is preferably injection-molded onto, cast onto and/or adhesively bonded to the radially outer region of the carrier, in order to realize simple and inexpensive producibility.

It is preferable for a force-fitting and/or form-fitting interface for connection to the respective articulated shaft to be formed integrally into the output shaft. It is thus possible here for the output shaft to be formed together with the carrier and with the respective interfaces in a single deformation process possibly composed of multiple steps. In an alternative embodiment, the output shaft comprises a toothing which engages into a corresponding toothing of a toothed rack and which thus directly transmits to the toothed rack the assistance force or assistance torque previously introduced via the carrier. It is thus possible here for the output shaft to be formed together with the carrier in a single deformation process, and for the toothing to subsequently be introduced on a corresponding shank region of the output shaft.

That region of the carrier which is surrounded by the worm gear toothing is preferably smaller than the non-surrounded region. In particular, the collar region h1-h2 surrounded by the worm gear toothing is smaller than the non-surrounded collar region h2, as a result of which, as already stated above, a relatively large region in the radial direction of the carrier is formed without the worm gear toothing, and the structural space can correspondingly be reduced.

In particular, the invention comprises a steering system for a motor vehicle, comprising an electric servomotor with an output shaft to which a worm is rotatably coupled, and comprising a worm gear which is coupled rotationally conjointly to a steering shaft and which, in engagement with the worm, forms a gear mechanism, wherein the electric servomotor introduces an assistance force or an assistance torque into the steering shaft via the gear mechanism composed of worm and worm gear for the purposes of assisting the steering movement, characterized in that the steering shaft is designed in accordance with individual or several of the features mentioned above.

### BRIEF DESCRIPTION OF THE FIGURES

Preferred further embodiments and aspects of the present invention will be discussed in more detail by way of the following description of the figures, in which:

FIG. 1 is a schematic perspective illustration of a steering system of a motor vehicle with a steering assistance means;

FIG. 2 is a schematic perspective illustration of an output shaft with a worm gear;

FIG. 3 is a schematic perspective illustration of an output shaft with a carrier formed in one piece therewith;

FIG. 4 is a schematic sectional illustration of an output shaft with a worm gear applied to the carrier shown in FIG. 3;

FIG. 5 is a schematic sectional illustration perpendicular to the axis direction of the worm gear from FIG. 4;

FIG. 6 shows an output shaft with a carrier formed integrally therewith in a further exemplary embodiment;

FIG. 7 is a schematic sectional illustration through the output shaft of FIG. 6 with applied worm gear toothing; and

FIG. 8 is a schematic perspective illustration of an output shaft in a further exemplary embodiment; and

FIG. 9 is a schematic perspective illustration of an output shaft in a further exemplary embodiment; and

FIG. 10 is a schematic perspective illustration of an electric steering assistance device according to the invention.

### DETAILED DESCRIPTION OF PREFERRED EXEMPLARY EMBODIMENTS

Preferred exemplary embodiments will be described below on the basis of the figures. Here, identical or similar elements, or elements of identical action, are denoted by identical reference designations in the various figures, and a repeated description of said elements will, in part, be omitted in the following description in order to avoid redundancies.

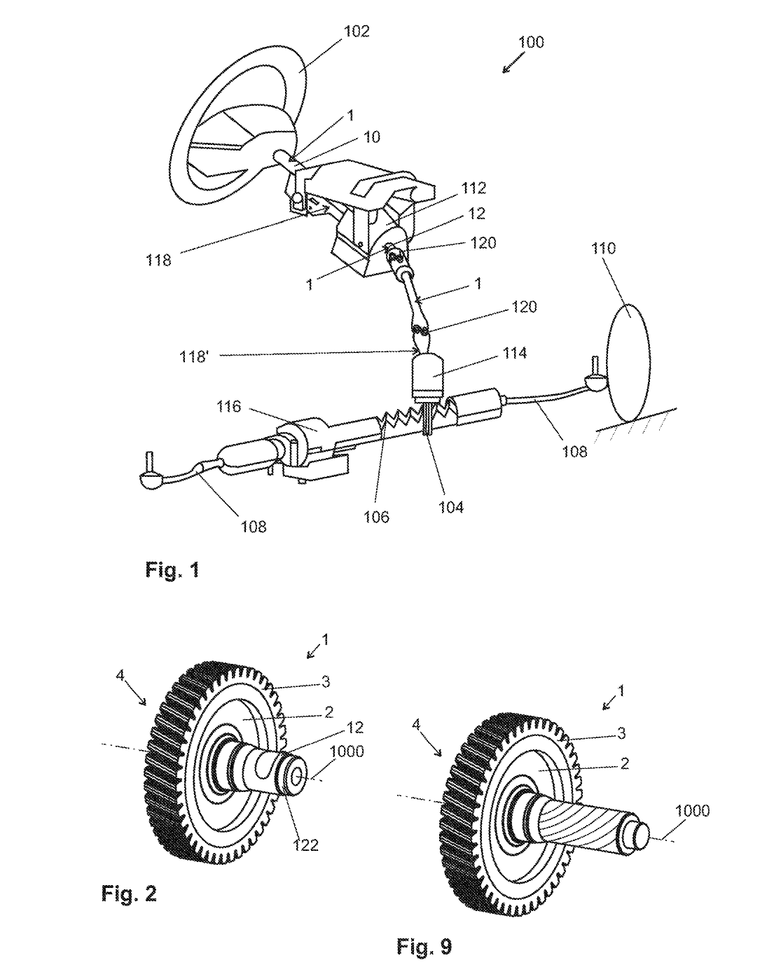

FIG. 1 is a schematic illustration of a motor vehicle steering system 100, wherein a driver can input a corresponding torque as a steering command into a steering shaft 1 by way of a steering wheel 102. The torque is then transmitted via the steering shaft 1 to a steering pinion 104 which meshes with a toothed rack 106, which then in turn transmits the predefined steering angle to the steerable wheels 110 of the motor vehicle via corresponding track rods 108.

An electric and/or hydraulic steering assistance means may be provided in the form of the steering assistance means 112 which is coupled to the steering shaft 1, steering assistance means 114 which is coupled to the pinion 104, and/or the steering assistance means 116 which is coupled to the toothed rack 106. The respective steering assistance means 112, 114 or 116 introduces an assistance torque into the steering shaft 1 or into the steering pinion 104 and/or introduces an assistance force into the toothed rack 106, whereby the driver is assisted with regard to the steering effort. The three different steering assistance means 112, 114 and 116 illustrated in FIG. 1 show possible positions for the arrangement thereof.

Normally, only a single one of the positions shown is occupied by a steering assistance means. The assistance torque or the assistance force which is to be imparted by the respective steering assistance means 112, one 14 or 116 in order to assist the driver is determined taking into consideration an input torque determined by a torque sensor 118. Alternatively, or in combination with the introduction of the assistance torque or assistance force, it is possible for an additional steering angle to be introduced into the steering system by way of the steering assistance means 112, 114, 116, which additional steering angle is added to the steering angle imparted by the driver by way of the steering wheel 102.

The steering shaft 1 has an input shaft 10, which is connected to the steering wheel 102, and an output shaft 12, which is connected to the toothed rack 106 by way of the steering pinion 104. The input shaft 10 and the output shaft 12 are coupled to one another in rotationally elastic fashion by way of a torsion bar (not visible in FIG. 1). Thus, a torque introduced into the input shaft 10 by a driver by way of the steering wheel 102 leads to a relative rotation of the input shaft 10 with respect to the output shaft 12 whenever the output shaft 12 does not rotate exactly synchronously with the input shaft 10. Said relative rotation between input shaft 10 and output shaft 12 may for example be measured by way of a rotational angle sensor and, owing to the known torsional rigidity of the torsion bar, it is correspondingly possible for a corresponding input torque relative to the output shaft to be determined. In this way, the torque sensor 118 is formed through the determination of the relative rotation between input shaft 10 and output shaft 12. A torque sensor 118 of said type is basically known and may be realized for example in the form of a rotary slide valve or of an electromagnetic or other measurement of the relative twist.

Correspondingly, a torque which is imparted by the driver to the steering shaft 1 or to the input shaft 10 by way of the steering wheel 102 will give rise to an assistance torque being introduced by one of the steering assistance means 112, 114, 116 only if the output shaft 12 is twisted relative to the input shaft 10 counter to the resistance of the torsion bar.

The torque sensor 118 may also alternatively be arranged at the position 118′, wherein then, the division of the steering shaft 1 into input shaft 10 and output shaft 12, and the rotationally elastic coupling by way of the torsion bar, are correspondingly realized at a different position in order that, from the relative twist of the output shaft 12 that is coupled by way of the torsion bar to the input shaft 10, a relative rotation and thus correspondingly an input torque and/or an assistance force to be input can be determined.

The steering shaft 1 in FIG. 1 furthermore comprises at least one cardanic joint 120 by way of which the profile of the steering shaft 1 in the motor vehicle can be adapted to the spatial conditions.

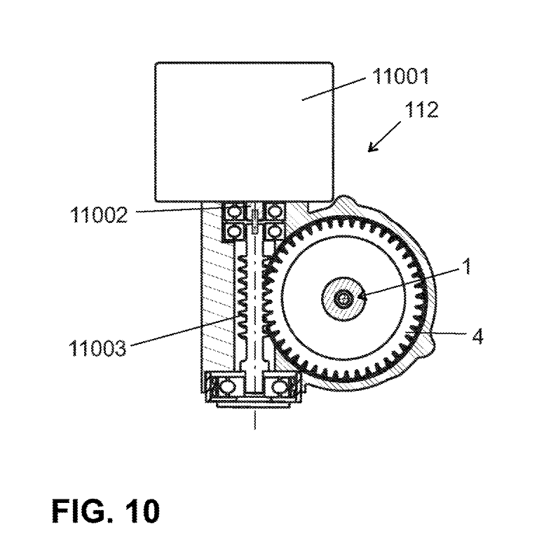

FIG. 10 illustrates an embodiment of a steering assistance device according to the invention. The steering system for a motor vehicle comprises an electric servomotor 11001, with an output shaft 11002 to which a worm 11003 is rotatably coupled, and comprises a worm gear 4, which is coupled rotationally conjointly to a steering shaft 1 and which, in engagement with the worm 11003, forms a gear mechanism, wherein the electric servomotor 11001 introduces an assistance force or an assistance torque into the steering shaft 1 via the gear mechanism composed of worm 11003 and worm gear 4 for the purposes of assisting the steering movement. The steering shaft 1 is illustrated in various embodiments in FIGS. 2 to 8 and will be described in more detail below.

FIG. 2 schematically shows a steering shaft 1 in a perspective illustration. Here, the steering shaft 1 is shown in the form of the output shaft 12, wherein the drive-output-side end 122 is shown here, said end entering into engagement, for example, with the cardanic joint 120 shown in FIG. 1 and correspondingly transmitting the steering torque to the downstream regions of the steering system. A carrier 2 is provided which is arranged rotationally conjointly on the output shaft 12 and on which there is arranged a worm gear toothing 3. By way of the worm gear toothing 3, the respective assistance force can be transmitted by the carrier 2 to the output shaft 12 via a corresponding drive worm. The worm gear toothing 3 forms, together with the carrier 2, a worm gear 4 which is connected rotationally conjointly to the output shaft 2 and which is correspondingly suitable for the introduction of the respective additional steering torque.

The carrier 2 defines, in combination with the worm gear toothing 3, a worm gear 4. It is correspondingly possible for a drive output of an electric motor or servomotor of the steering assistance means 112 to act on the worm gear 4. In one alternative, it is also possible for a hydraulic drive to be provided. The steering assistance means 112 therefore serves for introducing the assistance torque determined by way of the torque sensor 118 into the output shaft 12, and thus into all components of the motor vehicle steering system 100 situated downstream of the output shaft 12, for the purposes of steering assistance for the driver.

In order to be able to precisely determine the torque or the magnitude of the assistance force to be introduced via the worm gear 4, it is the case, as already described above, that the input shaft 10 and the output shaft 12 are connected rotationally elastically to one another such that the respective steering command that is introduced into the input shaft 10 by the driver by way of the steering wheel 102 results in assistance being provided to the driver by the steering assistance means 112, which assistance acts on the worm gear 4 and thus on the steering shaft 1. For this purpose, the torque sensor 118 is provided, which determines the relative rotation between the input shaft 10 and the output shaft 12, or the corresponding relative rotational angle between input shaft 10 and output shaft 12, and on this basis, the assistance torque to be provided by the steering assistance means 112 can be determined.

The carrier 2 is formed in one piece with the output shaft 12. Said single-part form may be realized for example by way of common deformation, preferably by way of cold extrusion of a corresponding semifinished part whose diameter is smaller than the outer diameter of the carrier 2 that is ultimately produced.

The worm gear toothing 3 composed of plastic is preferably injection-molded onto the carrier 2 in the radial circumferential region thereof, though may also be cast on or adhesively bonded on, for example by virtue of two separate shells being connected by adhesive bonding.

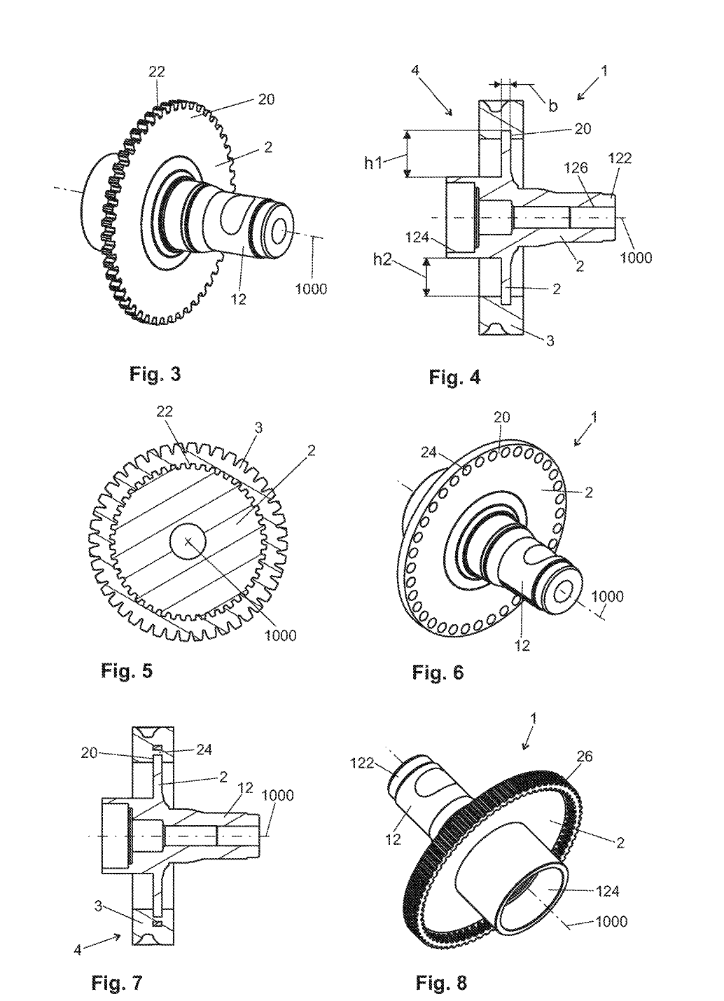

The output shaft 12 in combination with the carrier 2 is shown once again in FIG. 3 in a schematic perspective illustration. It can be seen that the carrier has, in its radially outer region 20, a toothing 22 which serves for entering into positively locking engagement with the applied worm gear toothing 3. It is correspondingly possible, at least in a direction of rotation in the event of a rotation of the worm gear that is then formed about the shaft axis 1000, for slippage of the worm gear toothing relative to the carrier and thus relative to the output shaft 12 to be prevented. In this way, it is possible for a reliable transmission of the respective forces to be realized even in the case of relatively high torques or relatively high assistance forces being transmitted by way of the steering assistance means.

FIG. 4 shows a schematic sectional illustration in a plane through the steering shaft 1, said plane extending through the shaft axis 1000. It is readily apparent that the outer shaft 12 is formed in one piece with the carrier 2, in particular by way of a deformation process. The drive-output-side end 122 and the drive-input-side end 124, which also has a receptacle 126 for a torsion bar (not shown here), are likewise formed in one piece in the output shaft 12.

As is readily apparent from the sectional illustration in FIG. 4, the carrier 2 is of substantially disk-shaped form. This means inter alia that the height h1 over the surface of the output shaft 12 to the radially outermost region of the carrier 2 is considerably greater than the width b of the carrier 2. This may also be expressed as follows: h1/b≧1. In other words, the carrier 2 is of disk-shaped form and correspondingly protrudes a considerable distance beyond the output shaft 12.

The worm gear toothing 3 is not only applied around the outermost circumference of the carrier 2 but also surrounds or encases the radially outer region 20 of the carrier 2. The height h2 between the outer surface of the output shaft 12 and the radially innermost extent of the worm gear toothing 3 is correspondingly smaller than the total height h1 of the carrier 2.

The radially outer region 20, which is surrounded by the worm gear toothing 3, of the carrier 2, that is to say h1-h2, is preferably considerably smaller than that region h2 of the carrier 2 which is not surrounded by the worm gear toothing 3. In other words, the height (h1-h2) in which the radially outer region 20 is surrounded is only relatively small in relation to the free height h2 of the carrier 2.

In this way, it is correspondingly possible for structural space to be saved in the region over the height h2, in which only the width b of the carrier 2 exists in the direction of the shaft axis 1000, such that the structural volume taken up by the worm gear 4 can be made as small as possible.

Owing to the fact that the carrier 2 is formed in one piece with the output shaft 12, it is furthermore possible to realize a high level of strength between carrier 2 and output shaft 12, such that a reliable transmission of torques introduced by way of the steering assistance means is ensured.

FIG. 5 shows a sectional illustration through the plane of the disk-shaped carrier 2. As already described above, the disk-shaped carrier 2 has, on its outer circumference, a toothing 22 which, as can be seen particularly clearly from FIG. 5, engages in form-fitting fashion with the worm gear toothing 3. Correspondingly, at least in the rotational direction, a form fit can be realized which permits a reliable transmission of the torque from the worm gear toothing 3 to the carrier 2 and correspondingly to the output shaft 12.

FIG. 6 schematically shows a further embodiment of the steering shaft 1, wherein in this case, the output shaft 12 is again formed in one piece with the carrier 2. Here, in the radially outer region 20 of the carrier 2, bores 24 are provided which extend parallel to the shaft axis 1000 and which likewise serve for connecting the worm gear toothing in form-fitting fashion to the carrier 2.

This can be seen in FIG. 7 in a schematic sectional illustration in a plane running through the shaft axis 1000. The worm gear toothing 3 extends correspondingly through the bores 24. This may be realized by virtue of the worm gear toothing 3 being injection-molded onto the radially outer region 20 of the carrier 2, in such a way that the plastics material of the worm gear toothing 3 flows through the bores 24 and correspondingly realizes a positively locking connection of the worm gear toothing 3 to the carrier 2.

FIG. 8 shows a further schematic perspective illustration of a steering shaft 1 with an output shaft 12. Here, a ring 26 generated parallel to the shaft axis 1000 during the extrusion is formed with an internal and an external toothing, by way of which a form-fitting connection between carrier 2 and worm gear toothing 3 can be realized, wherein, owing to the widened structure of the ring 26, the worm gear toothing 3 can be made even more compact through utilization of the high strength of said ring, and thus it is additionally possible for structural space to be saved.

In this case, too, the worm gear toothing 3 is in turn wider than the width b of the carrier in the direction of the shaft axis 1000. Correspondingly, it is possible in this way, too, to provide a particularly compact output shaft 12, which correspondingly is provided at a particularly small structural volume at least in the region of the structural space around the output shaft 12, in which the carrier 2 has a free height h2.

Correspondingly, by way of the above-described form of the worm gear 5, it is possible to realize a compact and space-saving construction, wherein at the same time, the number of components required is reduced, and increased strength of the worm gear 4 can be realized.

The drive-output-side end 122 of the output shaft 12 provides a form-fitting interface to the respective articulated shaft, for example via the cardan joint 120. The drive-input-side end 124 likewise provides a force-fitting or form-fitting interface to the torsion bar.

FIG. 9 illustrates an alternative embodiment in which the output shaft 12 has a toothing which engages into a corresponding toothing of a toothed rack 106 and which thus directly transmits to the toothed rack 106 the assistance force or the assistance torque previously introduced via the carrier 2. Here, it is also possible in this example for the output shaft to be formed together with the carrier in a single deformation process, wherein the toothing can subsequently be applied to a corresponding shank region of the output shaft.

Where applicable, all individual features illustrated in the individual exemplary embodiments may be combined with one another and/or exchanged for one another without departure from the scope of the invention.

### LIST OF REFERENCE DESIGNATIONS

1 Steering shaft
10 Input shaft
12 Output shaft
100 Motor vehicle steering system
102 Steering wheel
104 Steering pinion
106 Toothed rack
108 Track rod
110 Steerable wheel
112 Steering assistance means
114 Steering assistance means
116 Steering assistance means
11001 Servomotor
11002 Output shaft
11003 Worm
118 Torque sensor
118′ Torque sensor
120 Cardanic joint
122 Drive-output-side end
124 Drive-input-side end
126 Receptacle for torsion bar
1000 Shaft axis
2 Carrier
20 Radially outer region
22 Toothing
24 Bore
26 Ring
3 Worm gear toothing
4 Worm gear
h1 Height of the carrier over the output shaft
h2 Spacing between output shaft and worm gear toothing
b Width of the carrier

1.-8. (canceled)

9. A steering shaft for a motor vehicle steering system for use with a steering assistance means, the steering shaft comprising:
an output shaft;
a carrier that is connected rotationally conjointly to the output shaft; and
a worm gear toothing disposed on a radially outer region of the carrier, the worm gear toothing comprised of plastic and forming a worm gear for connection to a steering assistance means,
wherein the carrier and the output shaft are comprised of a single piece.

10. The steering shaft of claim 9 wherein the carrier has a disk-shaped form and a ratio of a height of the carrier beyond the output shaft to a width of the carrier is greater than or equal to one.

11. The steering shaft of claim 9 wherein the radially outer region of the carrier further comprises at least one of a knurling, a toothing, bores parallel to an axis of the output shaft, or a form-fitting structure that helps create a form-fitting connection to the worm gear toothing.

12. The steering shaft of claim 9 wherein a height of the radially outer region of the carrier that is surrounded by the worm gear toothing is smaller than a height of a radially-extending portion of the carrier beyond the output shaft that is not surrounded by the worm gear toothing.

13. The steering shaft of claim 9 wherein the carrier and the output shaft are integral.

14. The steering shaft of claim 9 further comprising at least one of a force-fitting interface or a form-fitting interface disposed integrally in the output shaft for connection to an articulated shaft.

15. A method for producing a steering shaft for a motor vehicle, the method comprising:
connecting a carrier to an output shaft in a rotationally-conjoint manner; and
forming a worm gear toothing on a radially outer region of the carrier, the worm gear toothing comprised of plastic and forming a worm gear for connection to a steering assistance means.

16. The method of claim 15 further comprising forming the carrier and the output shaft jointly by deformation or cold extrusion.

17. The method of claim 15 further comprising at least one of injection molding, casting, or adhesively bonding the worm gear toothing to or onto the radially outer region of the carrier.

18. The method of claim 15 further comprising forming integrally into the output shaft at least one of a force-fitting interface or a form-fitting interface for connection to an articulated shaft.

19. A steering system for a motor vehicle, the steering system comprising:
an electric servomotor with an output shaft to which a worm is rotatably coupled; and
a worm gear that is coupled rotationally conjointly to a steering shaft, wherein the worm gear engages with the worm to form a gear mechanism,
wherein the electric servomotor introduces an assistance force or an assistance torque into the steering shaft via the gear mechanism for assisting a steering movement of the steering system, wherein the steering shaft comprises
an output shaft,
a carrier that is connected rotationally conjointly to the output shaft of the steering shaft, wherein the carrier and the output shaft are comprised of a single piece, and
a worm gear toothing disposed on a radially outer region of the carrier, the worm gear toothing forming the worm gear that engages with the worm of the electric servomotor.
